(19) United States
(12) Patent Application Publication
(10) Pub. No.: US 2014/0188573 A1
(43) Pub. Date: Jul. 3, 2014

(54) AGRICULTURAL INPUT PERFORMANCE EXPLORATION SYSTEM

(71) Applicant: PIONEER HI-BRED INTERNATIONAL, INC., Johnston, IA (US)

(72) Inventors: Donald Avey, Ankeny, IA (US); Phillip L. Bax, Johnston, IA (US)

(73) Assignee: PIONEER HI-BRED INTERNATIONAL, INC., Johnston, IA (US)

(21) Appl. No.: 13/793,693

(22) Filed: Mar. 11, 2013

Related U.S. Application Data
(60) Provisional application No. 61/747,602, filed on Dec. 31, 2012.

(51) Int. Cl. G06Q 10/06; G06Q 50/02

(52) U.S. Cl. CPC G06Q 10/0639; G06Q 50/02
USPC 705/7.39; 705/7.38

(57) ABSTRACT

Methods, apparatuses and computer program products are provided for facilitating the exploration and evaluation of the comparative performance of agricultural inputs. Methods are provided that include receiving selection of one or more primary agricultural inputs and one or more comparison agricultural inputs. The methods further include accessing one or more primary data points comprising at least one performance measurement regarding the primary agricultural input and accessing one or more comparison data points comprising at least one performance measurement regarding the comparison agricultural input. The methods also include determining one or more comparative performance data points based on the primary and comparison data points and causing information regarding the comparative performance data points to be displayed.

### CROSS REFERENCE TO RELATED APPLICATIONS

This application claims the benefit of priority to U.S. Provisional Application No. 61/747,602, titled AGRICULTURAL INPUT PERFORMANCE EXPLORATION SYSTEM, which was filed Dec. 31, 2012, and is hereby incorporated by reference in its entirety.

### FIELD OF APPLICATION

Embodiments of the present invention relate generally to systems, methods, and computer program products for evaluating the performance of agricultural inputs, and more particularly to systems, methods, and computer program products which facilitate the exploration and evaluation of the comparative performance of agricultural inputs.

### BACKGROUND

Evaluating the performance of agricultural inputs is both a highly useful and exceedingly complex endeavor. While vast amounts of data on the performance of wide varieties of agricultural inputs may be available to users, this data is often distributed over vast and disparate areas and, therefore, extracting useful information from the data may often be complicated and difficult. Thus, without sophisticated performance evaluation systems, it may be difficult or even impossible to draw meaningful conclusions from these large data sets. Such conclusions may be useful, for example, for consumers wishing to purchase or implement agricultural inputs, or to producers and/or sellers who wish to market various agricultural inputs to consumers in different areas.

### SUMMARY

A method, apparatus and computer program product are therefore provided according to an example embodiment of the present invention for facilitating the evaluation and exploration of performance characteristics of agricultural inputs. In this regard, the method, apparatus, and computer program product of one embodiment may allow a user to select multiple agricultural inputs and to view, explore, and/or predict various information regarding the comparative performances of the multiple agricultural inputs.

Thus, according to an example embodiment, a method for comparing a plurality of agricultural inputs is provided. The method of the example embodiment includes receiving selection of one or more primary agricultural inputs and one or more comparison agricultural inputs. The method further includes accessing one or more primary data points respectively comprising at least one geographic location and at least one performance measurement regarding at least one of the primary agricultural inputs, and accessing one or more comparison data points respectively comprising at least one geographic location and at least one performance measurement regarding at least one of the comparison agricultural inputs. The method also includes determining one or more comparative performance data points based on the primary and comparison data points. Each comparative performance data point respectively comprises at least one geographic location and at least one indication of a performance advantage or disadvantage. Finally, the method of the example embodiment further includes causing information regarding the comparative performance data points to be displayed.

According to another example embodiment, an apparatus for comparing a plurality of agricultural inputs is provided. The apparatus of the example embodiment includes at least one processor and at least one memory storing computer program code therein. The memory and computer program code are configured, with the processor, to cause the apparatus to at least receive selection of one or more primary agricultural inputs and one or more comparison agricultural inputs. The apparatus is further caused to access one or more primary data points respectively comprising at least one geographic location and at least one performance measurement regarding at least one of the primary agricultural inputs, and to access one or more comparison data points respectively comprising at least one geographic location and at least one performance measurement regarding at least one of the comparison agricultural inputs. The apparatus is also caused to determine one or more comparative performance data points based on the primary and comparison data points. Each comparative performance data point respectively comprises at least one geographic location and at least one indication of a performance advantage or disadvantage. Finally, the apparatus of the example embodiment is further caused to cause information regarding the comparative performance data points to be displayed.

According to yet another example embodiment, a computer program product for comparing a plurality of agricultural inputs is provided. The computer program product of the example embodiment includes at a non-transitory computer-readable storage medium having program code instructions stored therein. The program code instructions being configured to, upon execution, cause an apparatus to at least receive selection of one or more primary agricultural inputs and one or more comparison agricultural inputs. The apparatus is further caused to access one or more primary data points respectively comprising at least one geographic location and at least one performance measurement regarding at least one of the primary agricultural inputs, and to access one or more comparison data points respectively comprising at least one geographic location and at least one performance measurement regarding at least one of the comparison agricultural inputs. The apparatus is also caused to determine one or more comparative performance data points based on the primary and comparison data points. Each comparative performance data point respectively comprises at least one geographic location and at least one indication of a performance advantage or disadvantage. Finally, the apparatus of the example embodiment is further caused to cause information regarding the comparative performance data points to be displayed.

According to another example embodiment, an apparatus for comparing a plurality of agricultural inputs is provided. The apparatus of the example embodiment includes means for receiving selection of one or more primary agricultural inputs and one or more comparison agricultural inputs. The apparatus further includes means for accessing one or more primary data points respectively comprising at least one geographic location and at least one performance measurement regarding at least one of the primary agricultural inputs, and means for accessing one or more comparison data points respectively comprising at least one geographic location and at least one performance measurement regarding at least one of the comparison agricultural inputs. The apparatus also includes means for determining one or more comparative performance data points based on the primary and comparison data points. Each comparative performance data point respectively comprises at least one geographic location and at least one indication of a performance advantage or disadvantage. Finally, the apparatus of the example embodiment further includes means for causing information regarding the comparative performance data points to be displayed.

### BRIEF DESCRIPTION OF THE SEVERAL VIEWS OF THE DRAWINGS

Reference will now be made to the accompanying drawings, which are not necessarily drawn to scale.

FIG. 1 is a schematic representation of an agricultural input performance exploration (AIPE) system configured in accordance with an example embodiment;

FIG. 2 is a block diagram of an apparatus that may be embodied by or associated with an electronic device, and may be configured to implement example embodiments of the present invention;

FIGS. 3a and 3b are flowcharts illustrating operations which may be performed in accordance with one or more example embodiments of the present invention;

FIGS. 4a, 4b, 4c, 4d, 5, and 6 are schematic representations of example user interfaces configured in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, processed and/or stored in accordance with embodiments of the present invention. Thus, use of any such terms should not be taken to limit the spirit and scope of embodiments of the present invention.

Throughout the description of the present invention, examples may be provided in the forms of lists. It will be understood that the inclusion of such lists, even lists which include a large number of alternatives and/or examples, should not be interpreted as limiting. That is, the scope of various aspects of the invention should not be interpreted as being limited to the provided examples, as numerous other examples may be possible and, indeed, may come to the mind of a person of skill in the art.

The present application is generally directed to systems, methods, and computer program products for allowing users to evaluate, explore, and/or predict various performance characteristics of agricultural inputs, such as agricultural products, management practices and/or the like, and more particularly to systems, methods, and computer program products that facilitate the exploration, evaluation, and/or prediction of the comparative performance of various agricultural inputs. The systems, methods, and computer program products of example embodiments may thus provide a platform for the holistic analysis of agricultural inputs and other contributing factors, such as genetics, environmental characteristics, management practices, etc. This information may be used to increase performance, boost sales, reduce risk, improve products, and/or provide many other benefits to sellers and growers.

Embodiments of such agricultural input performance exploration (AIPE) systems, methods, and computer program products can be configured to receive, at least, one or more primary agricultural inputs and one or more comparison agricultural inputs. The embodiments of the AIPE systems, methods, and computer program products can be configured to then access one or more primary and comparison data points, and to determine, based on the primary and comparison data points, one or more comparative performance data points. The embodiments of the AIPE systems, methods, and computer program products can be further configured to then cause information regarding the comparative performance data points to be displayed. Embodiments may further provide additional filtering, analysis, presentation, and exploration functions and options, as will be detailed below.

As used herein, a “data point” refers to a discrete collection of data, including one or more performance indicators, such as one or more measurements, observations, experimental results, grow results, estimations, projections, predictions, or the like, or indications of the same. The performance indicators may indicate any number of performance characteristics, such as yield, standablity (e.g., lodging resistance), disease resistance, end product characteristics (e.g., oil content, ethanol yield, etc.), or any other performance characteristics. Each data point may, for example, additionally be associated with, e.g., comprise, one or more identifiers, such as a geographic location or other types of identifiers, as discussed below. Data points may further include other information relating to the performance indicators, such as, for example, information regarding circumstances surrounding a performance measurement or information regarding sales or marketing data.

Thus, for example, each of the primary and comparison data points referenced above may comprise at least one geographic location and at least one performance measurement respectively regarding the either primary or comparison agricultural input. Similarly, each of the comparative data points determined based on the primary and comparison data points may respectively comprise at least one geographic location and at least one indication of a performance advantage or disadvantage. It will be understood, however, that a data point need not, in all cases, be associated, e.g., comprise, a geographic location. Indeed, data points may instead (or additionally) be associated with other identifiers such as particular experiments, tracking names (e.g., a unique identifier used to track one or more data points), or other identifiers. However, in instances in which a geographic location is associated with a data point, it will be understood that, as used herein, a “geographic location” may represent any level of specificity and may represent a geographic area. For example, a geographic location may comprise geographic coordinates (e.g., longitude and latitude), an address, a geographic region (e.g., a state, county, etc.), a particular field, a management zone (e.g., an inter- or intra-field management zone), or even a portion of a field (such as, for example, a particular row within a field).

For the purposes of clarity and brevity of discussion, operations and features will now be described as being carried out simply by the “AIPE system.” However, it will be understood that, as will be described in further detail below, each of these operations may in actuality be performed, for example, by one or more apparatuses which may, for example, be embodied by or otherwise associated with one or more devices and/or network entities, such as one or more user devices and/or servers, and comprising means such as one or more processors, memory devices, communication interfaces, sensor and/or control interfaces or the like.

As discussed above, embodiments of the AIPE system may be configured to determine, and display information regarding, one or more comparative performance data points based on one or more primary data points and one or more comparison data points. The primary and comparison data points each comprise an identifier, such as a geographic location, and one or more performance measurements regarding at least one primary or comparison agricultural input. In this way, the AIPE system may allow a user to, for example, easily and intuitively compare or predict performance characteristics of multiple agricultural inputs.

For example, according to an example embodiment in which each data point is associated with a geographic location, the comparative performance data points may be displayed in conjunction with one or more graphical geographic representations, e.g., maps, so that a user may visualize the comparative performance characteristics of the primary agricultural input vs. the comparison agricultural input over a geographic area. According to a further example embodiment, the comparative data points may be displayed in accordance with a visual coding scheme, such as, for example, a color-coding scheme, to further facilitate quickly comparing performance characteristics of the one or more primary and one or more comparison agricultural inputs. According to an even further embodiment, the AIPE system may cause one or more informational layers to be displayed, such as over the graphical geographic representation and in conjunction with the comparative performance data points, to allow users to intuitively visualize and discern trends and relationships between the performance characteristics of various agricultural inputs and the circumstances surrounding the performance characteristics.

The performance measurements of the primary and comparison data points may be collected via any number of means. For example, one or more of the performance measurements may be collected via weighing (e.g., weighing harvested crops), or via a yield monitoring system which may, for example, monitor a crop yield as it is harvested, such as via one or more harvester-mounted sensors. According to another example embodiment, performance measurements may be collected via observations. For example, collecting performance measurements for lodging resistance might involve a user counting how many plants are standing and how many are lodged. Numerous other examples will immediately come to the mind of those skilled in the art. According to other example embodiments, one or more of the performance measurements may be collected from above-ground sensors, such as satellites or aircraft-mounted or drone-mounted sensors, or from various ground-based sensors.

According to further example embodiments, one or more of the performance measurements may comprise predicted or estimated performance measurements. The predicted or estimated performance measurements may, for example, be determined based on measurements collected via any of the aforementioned means. According other example embodiments, the predicted or desired performance measurements may, for example, be additionally or alternatively be determined based on other information or various modeling techniques, such as weather and/or crop modeling. According to an even further example embodiment, one or more of the performance measurements may comprise benchmark performance measurements, such as desired, expected, or typical performance measurements. These benchmark performance measurements may, for example be determined based on historical information, such as historical performance measurements; performance targets, such as quotas, or may even be arbitrarily chosen. According to other example embodiments, the benchmark performance measurements may, for example, comprise a compilation or average of performance measurements from various sources, such as from various fields or experiments.

Example embodiments of the AIPE system may be further configured to provide filtering options so that only those primary and/or comparison data points satisfying selected filtering criteria are used in determining the one or more comparative performance data points. For example, embodiments of the AIPE system may be configured to receive filtering criteria such as one or more geographic areas or locations (with any level of specificity, as discussed above); characteristics of one or more experiments represented by the one or more data points, such as one or more particular experiments, experiment types, experimental parameters, and/or experimental groups; and/or one or more tracking names.

Further examples of filtering criteria include information regarding circumstances surrounding a performance measurement, e.g., information regarding factors which have any potential to have contributed to the measured (or predicted, projected, estimated, etc.) performance associated with a given data point, such as information regarding weather or other environmental circumstances; one or more previous crops (e.g., one or more crops previously grown in the location); a tillage system; irrigation, such as an irrigation capacity, distribution, or system; equipment and/or equipment parameters used; growing year or portion of the year; one or more genetic characteristics, such as relative maturity or relative maturity zone, genotype, genetic family, lifecycle stage, input or output trait(s), a particular single or set of gene(s), molecular markers; one or more input or output traits; one or more measured plant traits, such as plant height, stalk or root lodging, etc.; chemicals applied and/or a timing of chemical application; phenology, such as phenological stage; development model(s); soil characteristics and/or measurements such as classification, temperature, electrical conductivity, organic matter content, fertility, topography, hydrology, elevation etc.; the type of performance indicator; other agricultural inputs that were applied or used, such as fertilizers, herbicides, insecticides, fungicides, nematicides, avicides, cultural practices, trait stewardship practices, or the like, methods and/or timing of application of any of the same; and/or how a measurement or observation was collected, such as the type of device, sensor, system or the like used to collect the measurement, whether the measurement was of a harvested or non-harvested crop, or, in an instance in which the performance measurement represents a prediction, estimation or the like, information regarding the model, algorithm, simulation or the like which was used in determining the prediction, estimation or the like.

Filtering criteria may additionally or alternatively include various data quality indications, e.g., any indications regarding a perceived or expected quality, e.g., accuracy, repeatability, variance, standard error, standard deviation, etc., of a data point. According to an example embodiment, the AIPE system may be configured to cause various data processing techniques, such as various statistical analysis techniques, to be applied to the data points to determine any of the various data quality indications.

Although a number of non-limiting examples of filtering criteria have been provided, it will be understood that any other number of other variables, characteristics, or other aspects of information associated with the data points may be received as filtering criteria in order to determine the primary and/or comparison data points that will be used in determining the one or more comparative performance data points.

Once the AIPE system has accessed and, according to some embodiments, filtered the primary and comparison data points, it may be configured to determine one or more comparative performance data points. According to some example embodiments, determining the one or more comparative performance data points may involve two procedures: a grouping procedure and a processing procedure. During the grouping procedure, the AIPE system may determine one or more comparative sets, each comparative set comprising a primary group of one or more primary data points and a comparison group of one or more comparison data points. These sets may then be processed according to one or more data processing techniques during the processing procedure.

The AIPE system may be configured to determine these groups and sets of groups based on any number commonalities, the commonalities being selected from any characteristics of the data points, e.g., information contained in the data points, such as, for example, any of the filtering criteria discussed above. According to one example embodiment, the comparative sets may be determined based on a geographic location commonality. Thus, for example, a first comparative set may comprise a primary group and comparison group, each group comprising data points with the same (or similar) geographic locations. Example embodiments of the AIPE system may allow a user to select one or more commonalities or combinations of commonalities to be used in the grouping procedure. For instance, a user may determine that the primary and comparison groups may comprise data points from the same experiment instead of the same geographic location, or with the same planting year and the same geographic location, etc. According to other example embodiments, the AIPE system may be configured to determine commonalities, such as via various data analysis procedures, some examples of which are provided later in this description.

Further example embodiments of the AIPE system may permit even more precise control over the grouping procedure. For example, example embodiments of the AIPE system may be configured to receive comparison options which may be used to filter the comparative sets. The comparison options may include, for example, a data point threshold, such as a minimum number of data points per group (e.g., if a given commonality yields a comparative set comprising a group containing less than the minimum number of data points, that comparative set may be filtered, such as by being excluded from the processing phase); a proximity threshold (e.g., a maximum distance, as may be measured in geometric units or some other metric such as intervening strips, between the one or more data points in the primary group and the one or more data points in the comparison groups); and/or various data quality parameters. Further examples of comparison options that may be used include a location number threshold (e.g., a minimum number of locations or instances which must be represented amongst data points within a group), and/or a relative maturity difference threshold (e.g., a maximum difference in relative maturity between a primary and comparison group). Thus, the AIPE system may, via the grouping procedure, establish bases for comparison by creating sets including groups of primary and comparison data points based on one or more commonalities and, according to certain example embodiments, filtering those sets based on one or more comparison options, such that one or more comparative performance data points may be determined based on each set using one or more data processing techniques in the processing phase, as will be discussed.

In this regard, the processing phase may involve any type of processing, from simple difference calculations, such as determining a difference between the one or more performance measurements of the primary data points of the primary group (e.g., an average performance measurement in an instance in which the primary group contains more than one primary data points) and the one or more performance measurements of the comparison data points of the comparison group (e.g., an average performance measurement in an instance in which the comparison group contains more than one comparison data points), to more complex processing techniques. For example, the AIPE system may utilize data processing techniques such as paired T-testing, variance analysis (e.g., analysis of variance (AOV)), paired regression analysis, multi-variate regression analysis, correlation analysis, means testing, multiple range testing, partial least squares (PLS) analysis, mixed model analysis, and/or biploting. The AIPE system may also or alternatively use machine learning-based, or modeling-based data processing techniques, such as data processing techniques based on crop growth models, weather models, financial models, resource optimization models, and/or scenario planning models. Regardless of the data processing technique(s) used, the end result of the processing phase is one or more comparative performance data points which, for example, may respectively comprise one or more comparative performance indications, such as an indication of a performance advantage or disadvantage.

According to another example embodiment, the AIPE system may be further configured to engage in further processing phases. That is, the AIPE system may be further configured to perform various data processing techniques, such as those mentioned above, on the comparative performance data points determined during the initial processing phase. According to yet another example embodiment, the AIPE system may be further configured to receive selection of one or more data processing techniques, so that, for example, a user may select one or more data processing techniques that are to be used by the AIPE system during the initial or subsequent processing phases.

Having determined one or more comparative performance data points, example embodiments of the AIPE system may be configured to cause information regarding the comparative performance data points to be displayed. For example, the AIPE system may be configured to cause one or more graphical geographic representations, e.g., maps, to be displayed and to further cause respective graphical representations of the comparative performance data points to be displayed in conjunction with, e.g., overlaying, the one or more graphical geographic representations. According to another example embodiment, the AIPE system may be configured to cause the information regarding the comparative performance data points to be displayed via one or more tabular representations, via one or more graphs, and/or via any number of other information display techniques. According to yet another example embodiment, the AIPE system may be configured to receive selection of one or more information display techniques and to cause the information regarding the comparative performance data points to be displayed via the selected information display techniques.

According to certain example embodiments, the AIPE system may be configured to cause the graphical representations of the comparative performance data points to be displayed in accordance with a visual coding scheme. Thus, according to one example embodiment, the AIPE system may, for example, be configured to cause the comparative performance data points to be displayed as visually-coded, e.g., color-coded, dots or symbols overlaying the one or more graphical geographic representations. Thus, the AIPE system may, for example, be configured to cause degrees of performance advantage or disadvantage to be displayed via colors such that comparative performance data points indicative of a large performance advantage may, for example, be displayed in one color, such as green, while data points indicative of a large performance disadvantage to be displayed in another color, such as red. In this way, a user may quickly and intuitively appreciate the relative performance advantages and/or disadvantages of the primary and comparison agricultural inputs over a geographical area.

According to other example embodiments, the AIPE system may be configured to additionally or alternatively cause a tabular representation of the information regarding the comparative performance data points to be displayed. According to further embodiments, the AIPE system may be configured to cause various other representations of information regarding the comparative performance data points to be displayed, such as graphs, plots, charts, multidimensional displays or the like, including combinations of the same, or other examples which will be apparent to persons of skill in the art. According to yet another example embodiment, such as an example embodiment in which one or more performance measurements may represent predictions, projections, estimates or the like, the AIPE system may be configured to cause information regarding the comparative performance data points to be displayed based on a modeled output, such as by causing information regarding frequencies of occurrence or other depictions of probability, predicted values, or risk assessments to be displayed. Additional example embodiments may further display related data, such as weather or other environmental data, soil data, data from other agricultural inputs, or any other associated data in conjunction with the information regarding the comparative performance data points.

Example embodiments of the AIPE system may be further configured to receive selection of a representation of a particular comparative performance data point and, in response, cause further information regarding the comparative performance data point to be displayed. The further information may, for example, represent information regarding a commonality used during the grouping procedure. Thus, for example, in an instance in which, during the grouping procedure, sets of groups were determined based on a geographic location, receiving selecting of a particular comparative performance data point may result in the AIPE system causing information regarding a geographic location associated with the comparative data point to be displayed. The information regarding the geographic location may, for example, include information regarding soil, such as a soil maps; topography, such as a topographical map; weather or other environmental factors; and/or other information regarding the geographic location.

It will be understood that the further information regarding the comparative performance data point may, for example, additionally or alternatively include data associated with the one or more primary and comparison data points upon which the determination of the comparative performance data point was based. Thus, certain embodiments of the AIPE system may be configured, for example, to allow a user to “drill down” on a particular comparative data point of interest and examine aspects of its component data, e.g., information regarding the primary and comparison data points upon which the particular comparative performance data point was based. Thus, for example, an example embodiment of the AIPE system may be configured to receive selection of a particular comparative data point associated with a particular geographic area and, in response, cause information regarding primary and comparison data points associated with the area (or locations lying within the area) upon which the particular comparative data point was determined. This may include, for example, causing a graphical geographical representation, e.g., a map, to be displayed in conjunction with graphical representations of the primary and comparison data points.

According to a further example embodiment, the further information regarding the comparative performance data point may comprise information regarding circumstances surrounding or characteristics of the performance measurements of the primary and comparison data points upon which determination of the comparative performance data point was based. Thus, upon receiving selection of a particular comparative performance data point, an example embodiment of the AIPE may be configured to display information regarding respective dates of collection; weather and/or environmental parameters; depictions of plant growth stages; input application dates (e.g., dates of application of the primary or comparison agricultural inputs or, in the case of crop inputs, growth stages); dates of implementation of management practices, such as tillage, weed control, pesticide or fertilizer application; or any other event or circumstances which has the potential to have impacted the performance measurements of the primary and/or comparison data points, such as information discussed above in regards to the filtering criteria. Further example embodiments of the AIPE system may be configured to generate reports based on selected filtering criteria.

According to yet another example embodiment, the AIPE system may be configured to cause one or more informational layers to be displayed, such as overlaying a graphical geographic representation. According to another example embodiment, the AIPE system may be configured to cause one or more informational layers to be displayed within, or overlaying a portion of, a generated report. The one or more informational layers may convey any type of information. For example, the one or information layers may convey information regarding sales or market data, information regarding circumstances surrounding or characteristics of the performance measurements (such as any of the information discussed above), information regarding any of the filtering criteria discussed above, information regarding any of the performance indicators discussed above, and/or information regarding any of the identifiers discussed above. The AIPE system may be further configured to receive selection of one or more informational layers that are to be displayed, such that, for example, a user may select the one or more informational layers that they wish to view. Multiple layers may, for example, be displayed overlaying one another.

Having thus described generally certain example features and operations of the AIPE system, embodiments of the present invention will be described more fully hereinafter with reference to the accompanying drawings. It should be understood that these drawings show some, but not all, embodiments of the invention. Indeed, various embodiments of the invention may be embodied in many different forms and should not be construed as limited to the embodiments set forth herein; rather, these embodiments are provided so that this disclosure will satisfy applicable legal requirements.

Additionally, as the term will be used herein, “circuitry” may refer to hardware-only circuit implementations (e.g., implementations in analog circuitry and/or digital circuitry); combinations of circuits and computer program product(s) including software and/or firmware instructions stored on one or more computer readable memories that work together to cause an apparatus to perform one or more functions described herein; and circuits, such as, for example, one or more microprocessors or portions of a microprocessors, that require software or firmware for operation even if the software or firmware is not physically present. This definition of “circuitry” is applicable to all uses of this term, including in any claims. As another example, the term “circuitry” also includes implementations comprising one or more processors and/or portion(s) thereof and accompanying software and/or firmware. As another example, the term “circuitry” also includes, for example, an integrated circuit or applications processor integrated circuit for a portable communication device or a similar integrated circuit in a server, a network device, and/or other computing device.

As defined herein, a “computer-readable storage medium” refers to a non-transitory physical storage medium (e.g., volatile or non-volatile memory device), and can be differentiated from a “computer-readable transmission medium,” which refers to an electromagnetic signal.

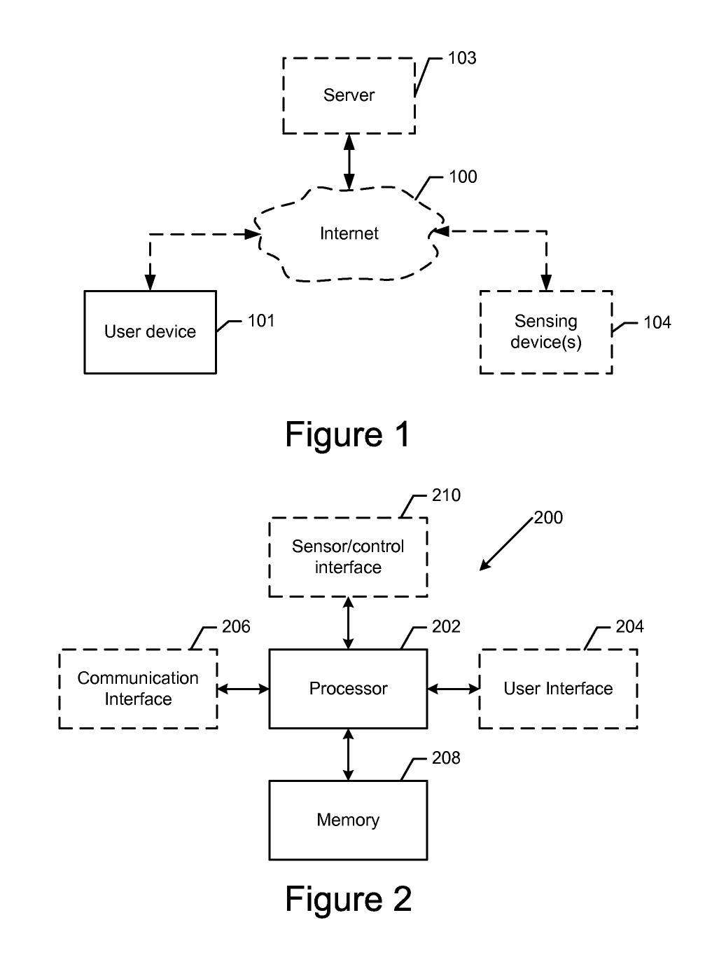

FIG. 1 illustrates a block diagram of an AIPE system. While FIG. 1 illustrates one example of a configuration of an AIPE system, numerous other configurations may be used to implement embodiments of the present invention. These other configurations may, for example, include configurations in which one or more of the depicted devices are in direct communication with one another, as opposed to communicating via a common network, such as the internet 100.

With reference to FIG. 1, however, the AIPE system includes a user device 101, and may include a network entity, such as a server 103, and/or one or more sensing devices 104. The user device 101 may, according to some embodiments, comprise a device that is configured to communicate over one or more common networks, e.g., a network to which the user device 101, server 103, and/or sensing devices 104 are in communication with, such as the internet 100. For example, the user device 101 may be a mobile terminal, such as a mobile telephone, PDA, laptop computer, tablet computer, or any of numerous other hand held or portable communication devices, computation devices, content generation devices, content consumption devices, or combinations thereof.

The server 103 may be any type of network-accessible device that includes storage and may be configured to communicate with the user device 101 over one or more common networks, such as the internet 100. The server 103 may store data, such as any data points discussed herein, geographic data, weather data, weather models, product information, account information, sales information, and/or customer information, along with any other type of content, data or the like which may, for example, be provided to the user device 101 during use of the AIPE system. The server 103 may also communicate with other servers or devices, such as other user devices, as well as other servers or data terminals including servers and systems providing data similar to that described above, over one or more networks, such as the internet 100. The user device 101 and/or server 103 may include or be associated with an apparatus 200, such as shown in FIG. 2, configured in accordance with embodiments of the present invention, as described below. According to some example embodiments, some or all of the abovementioned data may be stored locally, e.g., in a memory associated with user device 101, instead of or in addition to in the server 103.

The sensing device(s) 104 may include any sensing device configured to gather information, such as information which may be included in or otherwise associated with, or used in the determination of, any information included in or otherwise associated with a data point as discussed above. For example, the sensing device(s) 104 may include one or more of weighing devices; yield monitoring devices or systems; devices configured to measure or monitor soil, weather, and/or environmental conditions; or any number of other sensing devices.

As shown in FIG. 1 and mentioned above, the user device 101, server 103, and/or sensing device(s) 104 may communicate with one another, such as via a common network, such as the internet 100. The user device 101, server 103, and/or sensing device(s) 104 may connect to the common network, e.g., the internet 100, via wired or wireless means, such as via one or more intermediate networks. For example, the user device 101, server 103, and/or sensing device(s) 104 may connect with the common network, e.g., the internet 100, via wired means such as Ethernet, USB (Universal Serial Bus), or the like, or via wireless means such as, for example, WI-FI, BLUETOOTH, or the like, or by connecting with a wireless cellular network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network. The user device 101, server 103, and/or sensing device(s) 104 may also communicate with one another directly, such as via suitable wired or wireless communication means.

Example embodiments of the invention will now be described with reference to FIG. 2, in which certain elements of an apparatus 200 for carrying out various functions of the AIPE system are depicted. As noted above, in order to implement the various functions of the AIPE system, the apparatus 200 of FIG. 2 may be employed, for example, in conjunction with either or both of the user device 101 and the server 103 of FIG. 1. However, it should be noted that the apparatus 200 of FIG. 2 may also be employed in connection with a variety of other devices, both mobile and fixed, in order to implement the various functions of the AIPE system and therefore, embodiments of the present invention should not be limited to those depicted. It should also be noted that while FIG. 2 illustrates one example of a configuration of an apparatus 200 for implementing the functions of the AIPE system, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 200 for implementing the various functions of the AIPE system may include or otherwise be in communication with a processor 202, a communication interface 206, a sensor and/or control interface 210, and a memory device 208. As described below and as indicated by the dashed lines in FIG. 2, the apparatus 200 may also include a user interface 204, such as when the apparatus 200 is embodied by or otherwise associated with the user device 101. The user interface 204 may, for example, be configured to receive input regarding observational performance information. In some embodiments, the processor 202 (and/or co-processors or other processing circuitry assisting or otherwise associated with the processor 202) may be in communication with the memory device 208 via a bus configured to pass information among components of the apparatus 200. The memory device 208 may, for example, include one or more volatile and/or non-volatile memories. The memory device 208 may be configured to store information, data, content, applications, instructions, or the like, for enabling the apparatus 200 to carry out various functions in accordance with an example embodiment of the present invention. For example, the memory device 208 may be configured to store instructions, such as program code instructions, that, when executed by the processor 202, cause the apparatus 200 to carry out various operations.

The sensor and/or control interface 210 may include circuitry configured to interface with one or more sensors, such as any of the sensors discussed above, and/or to control one or more external devices and/or equipment, such as devices or equipment configured to apply or change agricultural inputs. Thus, according to some embodiments, the sensor and/or control interface 210 may include one or more ports, such as one or more USB, PCI ports or the like configured to establish a connection with the one or more external sensors, devices, and/or equipment. According to other embodiments, such as the embodiment depicted in FIG. 1, the external sensors, devices, and/or equipment may be accessible, for example, via a network, such as the internet 100. Thus, a wired or wireless connection between apparatus 200 and external sensors, devices, and/or equipment may be established via the communication interface 206 and the sensor and/or control interface 210 may be configured to, for example, access, read, translate, manage, format, or otherwise handle data received from or sent to the external sensors, devices, and/or equipment. In such an embodiment, sensor and/or control interface 210 may, alternatively or additionally, be embodied as software, such as program code instructions embodied in memory 208 and executable by processor 202.

The processor 202 may be embodied in a number of different ways. For example, the processor 202 may be embodied as one or more of a variety of hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading.

In an example embodiment, the processor 202 may be configured to execute instructions stored in the memory device 208 or otherwise accessible to the processor 202. Alternatively or additionally, the processor 202 may be configured to execute hard coded functionality. As such, whether configured by hardware or software methods, or by a combination thereof, the processor 202 may represent an entity (e.g., physically embodied in circuitry) capable of performing operations according to an embodiment of the present invention while configured accordingly. Thus, for example, when the processor 202 is embodied as an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor of a specific device (e.g., the user device 101 or the server 103) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202.

Meanwhile, the communication interface 206 may be any means such as a device or circuitry embodied in either hardware or a combination of hardware and software that is configured to receive and/or transmit data from/to a network, such as the internet 100, and/or any other device or module in communication with the apparatus 200. In this regard, the communication interface 206 may include, for example, an antenna (or multiple antennas) and supporting hardware and/or software for enabling communications with a wireless communication network. Additionally or alternatively, the communication interface 206 may include the circuitry for interacting with the antenna(s) to cause transmission of signals via the antenna(s) or to handle receipt of signals received via the antenna(s). In some environments, the communication interface 206 may alternatively or also support wired communication. As such, for example, the communication interface 206 may include a communication modem and/or other hardware/software for supporting communication via cable, digital subscriber line (DSL), universal serial bus (USB) or other mechanisms.

In some embodiments, such as instances in which the apparatus 200 is embodied by the user device 101, the apparatus 200 may include a user interface 204 in communication with the processor 202 to receive indications of user input and to cause audible, visual, mechanical or other output to be provided to the user. As such, the user interface 204 may, for example, include a keyboard, a mouse, a joystick, a display, a touch screen(s), touch areas, soft keys, a microphone, a speaker, or other input/output mechanisms. The processor 202 may be configured to control one or more functions of one or more user interface elements through computer program instructions (e.g., software and/or firmware) stored on a memory accessible to the processor 202 (e.g., memory device 208). In other embodiments, however, such as in instances in which the apparatus 200 is embodied by server 103, the apparatus 200 may not include a user interface 204.

In still other embodiments, multiple apparatuses 200 may be associated with respective devices, or the components of the apparatus 200 may be distributed over multiple devices. For example, a first apparatus 200 may be embodied by or otherwise associated with the server 103 and may not include a user interface 204, while a second apparatus 200 may be embodied by or otherwise associated with the user device 101 and may include a user interface 204. In this way, the two apparatuses 200 may effectively function as a single distributed apparatus 200, with input and output operations, e.g., receiving input and displaying output, taking place at the user device 101, while data processing operations, e.g., determining one or more comparative performance data points, taking place at the server 103. It should be understood, however, that in this case, the second apparatus associated with the user device 101 may still include a processor 202 and memory 208 and both apparatuses may still include communication interfaces 206.

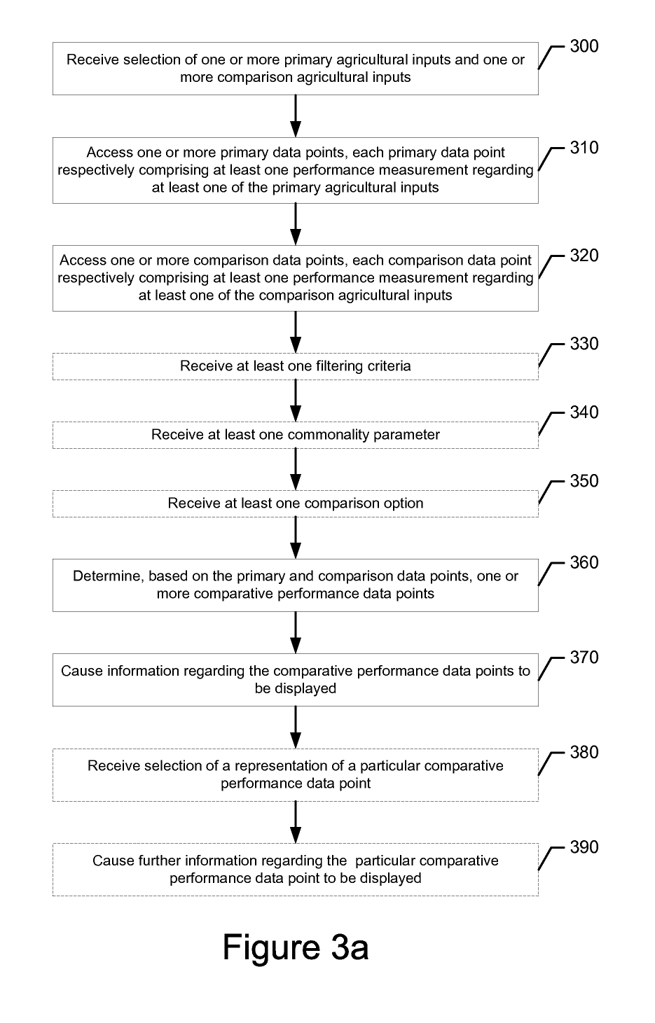

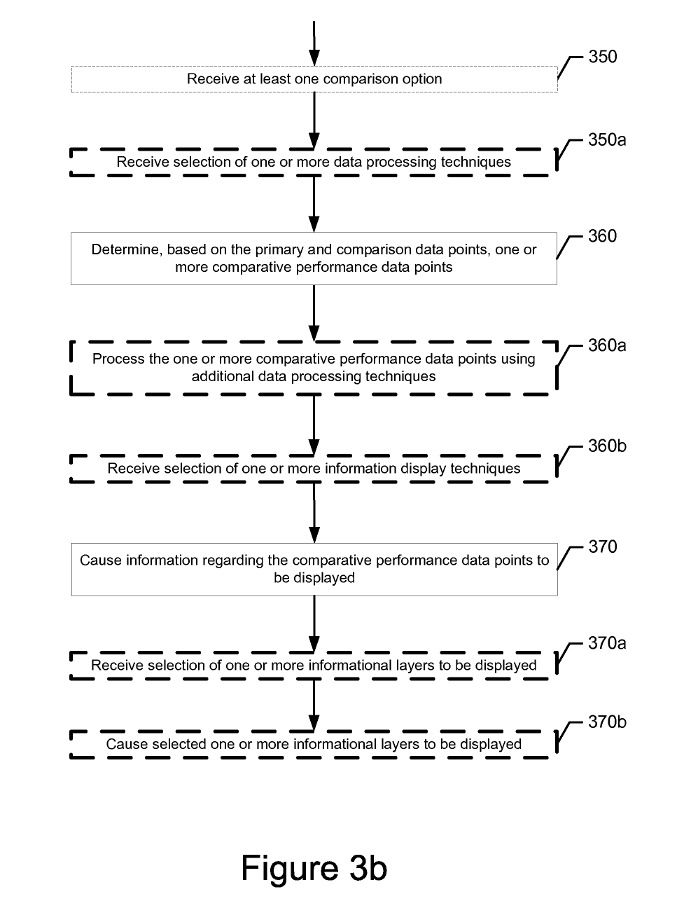

Referring now to FIGS. 3a and 3b, various operations of the AIPE system are according to example embodiments are depicted. It will be understood that FIG. 3b depicts operations 350a, 360a, 360b, 370a, and 370b of the AIPE system which may or may not be performed in addition to the operations depicted in FIG. 3a. As described below, the operations of FIGS. 3a and 3b may be performed by the apparatus 200, such as shown in FIG. 2, embodied by or otherwise associated with the user device 101 and/or the server 103. In this regard, the apparatus 200 embodied by or otherwise associated with the user device 101 and/or server 103 may include means, such as the processor 202, the memory 208, the user interface 204, the communication interface 206 or the like, for receiving selection of one or more primary agricultural inputs and one or more comparison agricultural inputs. See operation 300 of FIG. 3a. One or more primary agricultural inputs and one or more comparison agricultural inputs may, according to an example embodiment, be received from a user, such as via the user interface 204 of apparatus 200 embodied by or otherwise associated with the user device 101.

The apparatus 200 embodied by or otherwise associated with the user device 101 and/or server 103 may further include means, such as the processor 202, the memory 208, the user interface 204, the communication interface 206 and/or the like, for accessing one or more primary data points and one or more comparison data points. See operations 310 and 320 of FIG. 3a. The data points may, for example, be accessed from a memory associated with either or both of the user device 101 and/or the server 103. The primary data points may each respectively comprise at least one performance measurement regarding at least one of the primary agricultural inputs and the comparison data points may each respectively comprise at least one performance measurement regarding at least one of the comparison agricultural inputs. As discussed above, each of the data points may further comprise additional information, such as one or more identifiers and/or other information, such as is discussed above in regards to the filtering criteria and/or the commonalities. For example, the data points may each include one or more geographic locations representing, for example, a location from which their respective one or more performance measurements were obtained.

According to an example embodiment, the apparatus 200 embodied by or otherwise associated with the user device 101 and/or server 103 may further include means, such as the processor 202, the memory 208, the user interface 204, the communication interface 206 and/or the like, for receiving at least one filtering criteria. See operation 330 of FIG. 3a. According to yet another example embodiment, the apparatus 200 embodied by or otherwise associated with the user device 101 and/or server 103 may further include means, such as the processor 202, the memory 208, the user interface 204, the communication interface 206 and/or the like, for receiving at least one commonality and for receiving at least one comparison option. See operations 340 and 350 of FIG. 3a. As discussed above, the one or more filtering criteria may, according to an example embodiment, be used by the apparatus 200 to determine a filtered pool of primary and comparison data points (e.g., by excluding from the grouping and processing procedures any data points determined to not satisfy the one or more filtering criteria). Also as discussed above, the one or more commonalities may, according to yet another example embodiment, be used by the apparatus during a grouping process to determine one or more groups and sets of groups of primary and comparison data points from the filtered pool of data points. Finally, the one or more comparison options may be used by the apparatus 200 to determine, according to yet another example embodiment, a filtered pool of comparative sets to be used in the data processing procedure (e.g., by excluding from the data processing procedure any comparative sets determined not to satisfy the one or more comparison options). According to another example embodiment, the apparatus 200 may include means, such as the processor 202, the memory 208 and/or the like, for determining one or more commonalities. The one or more commonalities may be determined, for example, via one or more data processing techniques, such as modeling or machine-learning techniques, or any of the data processing techniques discussed above.

Turning briefly to FIG. 3b, apparatus 200 embodied by or otherwise associated with the user device 101 and/or server 103 may further include means, such as the processor 202, the memory 208, the user interface 204, the communication interface 206 and/or the like, for receiving selection of one or more data processing techniques, such as, for example, any of the data processing techniques discussed above. See operation 350a of FIG. 3b.

Apparatus 200 embodied by or otherwise associated with the user device 101 and/or server 103 may further include means, such as those mentioned above, for determining, based on the primary and comparison data points, one or more comparative performance data points. See operation 360 of FIG. 3a. The comparative data points may, according to an example embodiment, include at least one indication of a performance advantage or disadvantage, and/or a probability of the same. As discussed above, each of the comparative performance data points may, according to an example embodiment, further comprise additional information. For example, the comparative data points may each include one or more geographic locations. Also as discussed above, determining the one or more comparative performance data points may, according to certain example embodiments, may comprise a grouping procedure and/or a processing procedure such that, for example, determining the one or more comparative performance data points may be further based on one or more commonalities and/or one or more comparison options. As discussed above, the processing procedure may involve the use of one or more data processing techniques, such as, for example, any of the data processing techniques discussed above. According to an example embodiment, the data processing techniques used may comprise the one or more data processing techniques selected in operation 350a of FIG. 3b.

According to a further embodiment, and again turning briefly to FIG. 3b, the apparatus 200 embodied by or otherwise associated with the user device 101 and/or server 103 may further include means, such as those mentioned above, for processing the one or more comparative performance data points using one or more additional data processing techniques. See operation 360a of FIG. 3b. Thus, the apparatus 200 may process the comparative performance data points using, for example, any of the data processing techniques discussed above. According to a further example embodiment, the data processing techniques used may comprise the one or more data processing techniques selected in operation 350a of FIG. 3b.

Apparatus 200 embodied by or otherwise associated with the user device 101 and/or server 103 may further include means, such as those mentioned above, for causing information regarding the comparative performance data points to be displayed. See operation 370 of FIG. 3a. As discussed above, this information may, according to example embodiments, be caused to be displayed using one or more information display techniques such as via one or more graphical geographic representations, one or more tabular representations, one or more graphs, and/or via other methods. According to a further example embodiment, the information may be caused to be displayed in accordance with a visual coding scheme, such as, for example, a color coding scheme. According to a further embodiment, and again turning briefly to FIG. 3b, the apparatus 200 embodied by or otherwise associated with the user device 101 and/or server 103 may further include means, such as those mentioned above, for receiving selection of one or more information display techniques. See operation 360b of FIG. 3b. Thus, the apparatus of the further example embodiment may cause the information regarding the comparative performance data points is displayed in accordance with the selected one or more information display techniques.

According to yet another example embodiment and continuing to refer to FIG. 3b, the apparatus 200 embodied by or otherwise associated with the user device 101 and/or server 103 may further include means, such as those mentioned above, for causing one or more informational layers to be displayed. See operation 370b of FIG. 3b. As discussed above, the informational layers may convey any type of information. For example, the one or information layers may convey information regarding sales or market data, information regarding circumstances surrounding or characteristics of the performance measurements (such as any of the information discussed above), information regarding any of the filtering criteria discussed above, information regarding any of the performance indicators discussed above, and/or information regarding any of the identifiers discussed above. According to some example embodiments, multiple layers may be displayed, such as overlaying one another. According to a further example embodiment, the apparatus 200 may further include means, such as those discussed above, for receiving selection of one or more informational layers that are to be displayed, such that, for example, a user may select the one or more informational layers that they wish to view.

Apparatus 200 embodied by or otherwise associated with the user device 101 and/or server 103 may further include means, such as those mentioned above, for receiving selection of a representation of a particular comparative performance data point and, in response, causing further information regarding the particular comparative performance data point to be displayed. See operations 380 and 390 of FIG. 3a. According to an example embodiment, this may, for example, involve causing information regarding a geographic location associated with the particular comparative performance data point to be displayed.

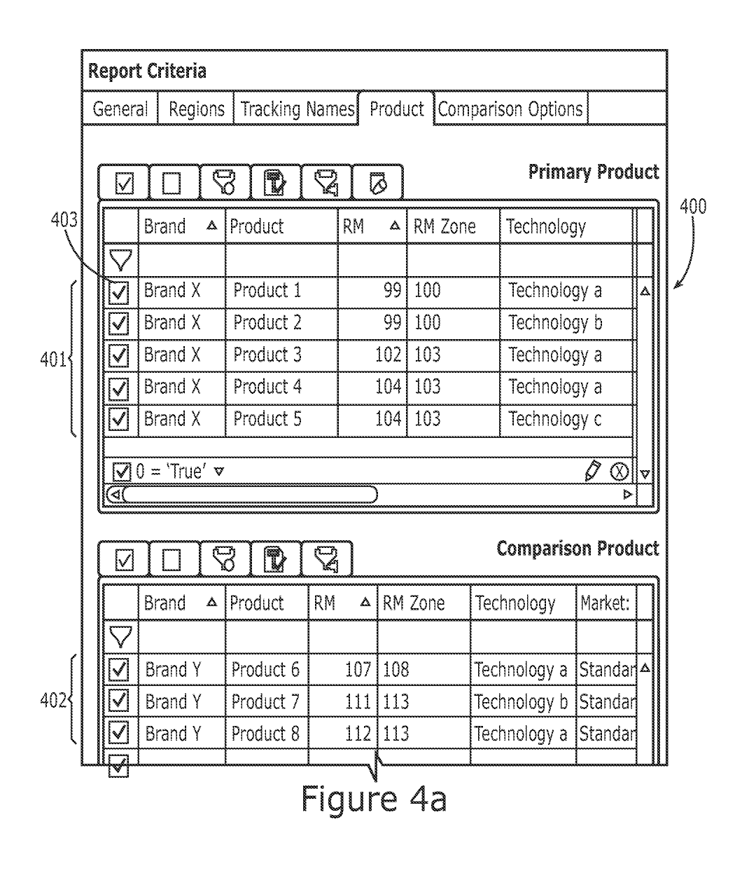

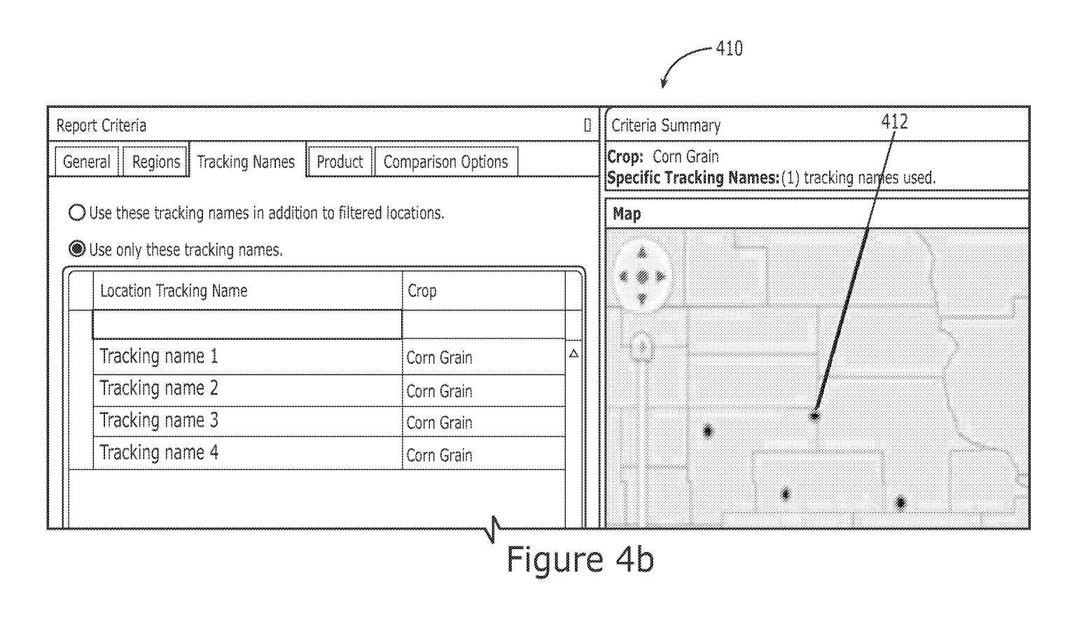

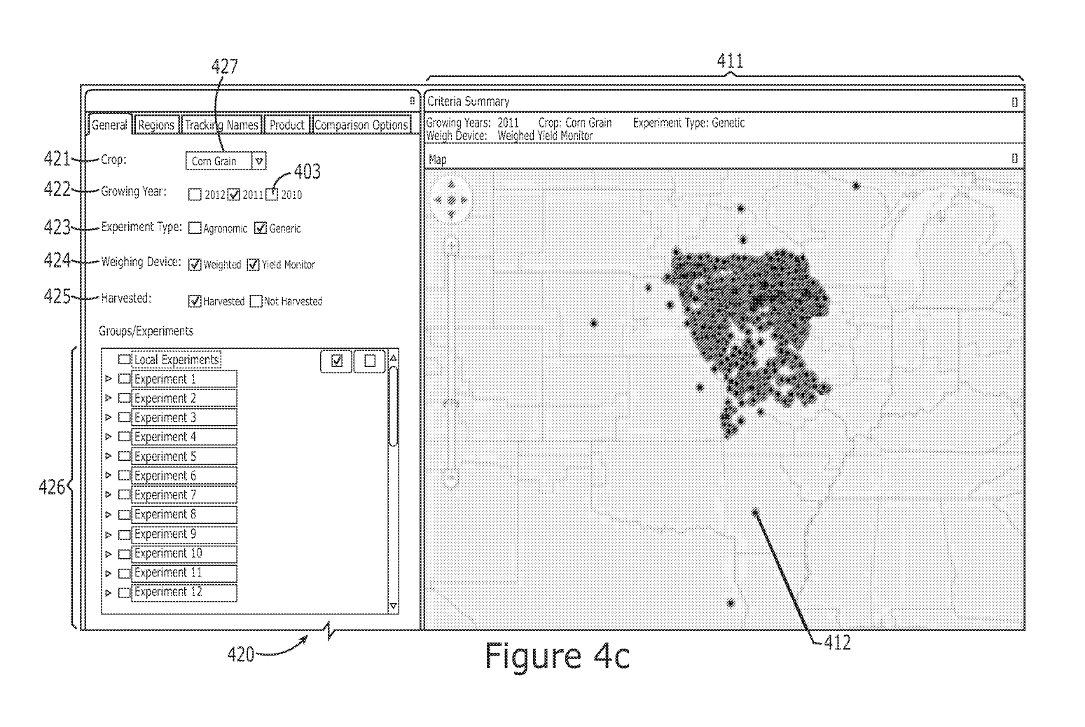

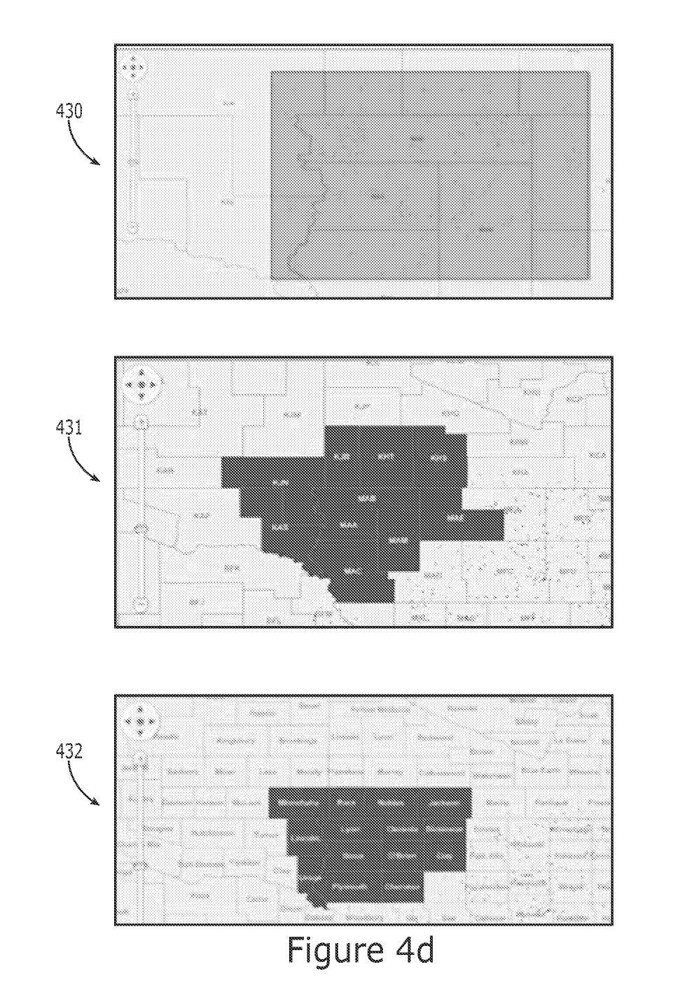

As mentioned at various points above, the operations of the AIPE system may involve receiving one or more selections and causing information to be displayed, such as via user interface 204 of apparatus 200 embodied by or otherwise associated with a user device 101 and/or a server 103. Thus, having discussed examples of operations and features of the AIPE system generally, reference will now be made to FIGS. 4a, 4b, 4c, 4d, 5, and 6 in order to discuss specific examples of user interfaces which may allow users to interact with the AIPE system in order to evaluate the comparative performance of agricultural inputs.

FIG. 4a represents an example of an “agricultural input selection” viewable area 400, e.g., a view that may be provided to a user to allow them to select one or more primary agricultural inputs, e.g., products, and one or more comparison agricultural inputs whose comparative performance they would like to evaluate. Accordingly, the agricultural input selection viewable area 400 may include lists of one or more primary agricultural inputs 401 and one or more comparison agricultural inputs 402, along with means for selection, such as check boxes 403. As shown, the lists of agricultural inputs may include various information and details including, but not limited to, a brand, a product name, a relative maturity (RM) (e.g., in the case of seed products), an RM zone, a technology, an associated market, and/or other information.

FIG. 4b represents one example of a viewable area which may be presented so as to allow selection of various filtering criteria. In particular, FIG. 4b represents an example of a “tracking name selection” viewable area 410, e.g., a view that may be provided to a user to allow them to select one or more tracking names. As shown, the tracking name selection viewable area 410 may further include an option for whether the user would prefer to use the selected tracking names in addition to additional filtering criteria, such as, as depicted, one or more geographic locations, or whether the user would prefer to filter the data points based only on the selected tracking names. Also of interest in this the tracking name selection viewable area is the “map view” 411. As shown, the map view 411 may, for example, display data points 412, e.g., primary or comparison data points, which satisfy any currently selected filtering criteria. Such a map view 411 may, for example, be provided in conjunction with any view configured for receiving filtering criteria so that a user may see how selecting particular filtering criteria may affect the filtered pool of data points.

FIG. 4c represents another example of a viewable area which may be presented so as to allow selection of various filtering criteria. In particular, FIG. 4c represents an example of a “general filtering criteria selection” viewable area 420, e.g., a view that may be provided to a user to allow them to select a variety of filtering criteria. As shown, the general filtering criteria selection viewable area 420 may allow a user to select filtering criteria such as a crop type 421, growing year 422, experiment type 423, weighing device 424, harvest status 425, and/or particular experiments 426. As shown the selections may be made, for example, via checkboxes 403 or drop-down menus 427. As with FIG. 4b, a map view 411 which may include data points 412 is also shown.

FIG. 4d represents three examples of viewable areas which may be presented so as to allow selection of a geographic location as a filtering criterion. In particular, FIG. 4d represents three examples of various means for selecting a geographic location as a filtering criterion: “geometric selection view” 430 represents a view configured to receive selection of a geographic location via the user drawing a geometric shape (or, according to other example embodiments, a freeform shape) on a graphical geographic representation, e.g., a map, using a cursor; “region selection view” 431 represents a view configured to receive selection of a geographic location via the user selecting one or more regions displayed via a map; and “county selection view” 432 represents a view configured to receive selection of a geographic location via a user selecting one or more counties displayed via a map. Additional or alternative views for receiving selection of a geographic location may also be provided. For example, example embodiments may provide options for creating and saving custom regions and for subsequently selecting such custom regions as a geographic location filtering criterion.

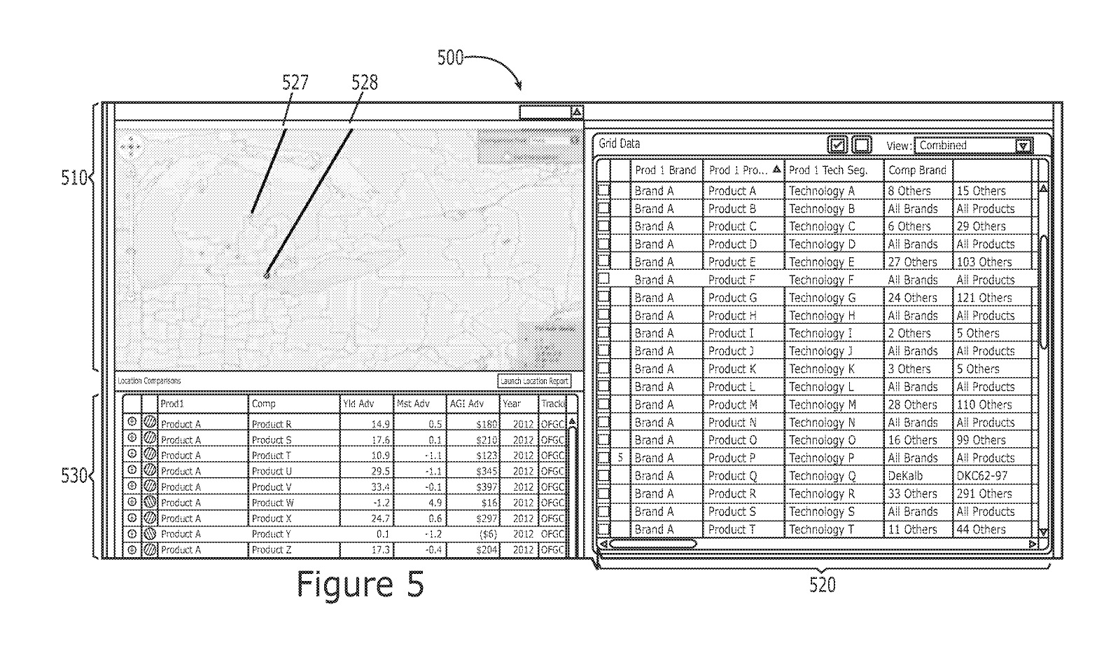

FIG. 5 depicts a “comparative performance” viewable area 500. As shown, the comparative performance viewable area 500 may include a graphical geographic representation 510 including representations of one or more comparative performance data points 527 overlaid thereon. As shown, the comparative performance data points 527 may be displayed in accordance with a visual coding scheme, such as a color coding scheme. A tabular representation 520 of information regarding the comparative performance data points is also depicted in FIG. 5. As shown, the tabular representation 520 may be displayed concurrently with the graphical geographic representation 510.

As also shown in FIG. 5, when selection of a particular comparative performance data point 528 is received, further information regarding the particular comparative performance data point 528 may be displayed, such as in the second tabular representation 530 depicted underneath the graphical geographical representation 510 in FIG. 5. As shown, the further information regarding the particular comparative performance data point 528 may include information regarding the primary and comparison data points upon which the comparative data point was determined. For example, as shown here, information regarding all primary and comparison data points associated with a particular geographic location is displayed in the second tabular representation 530.

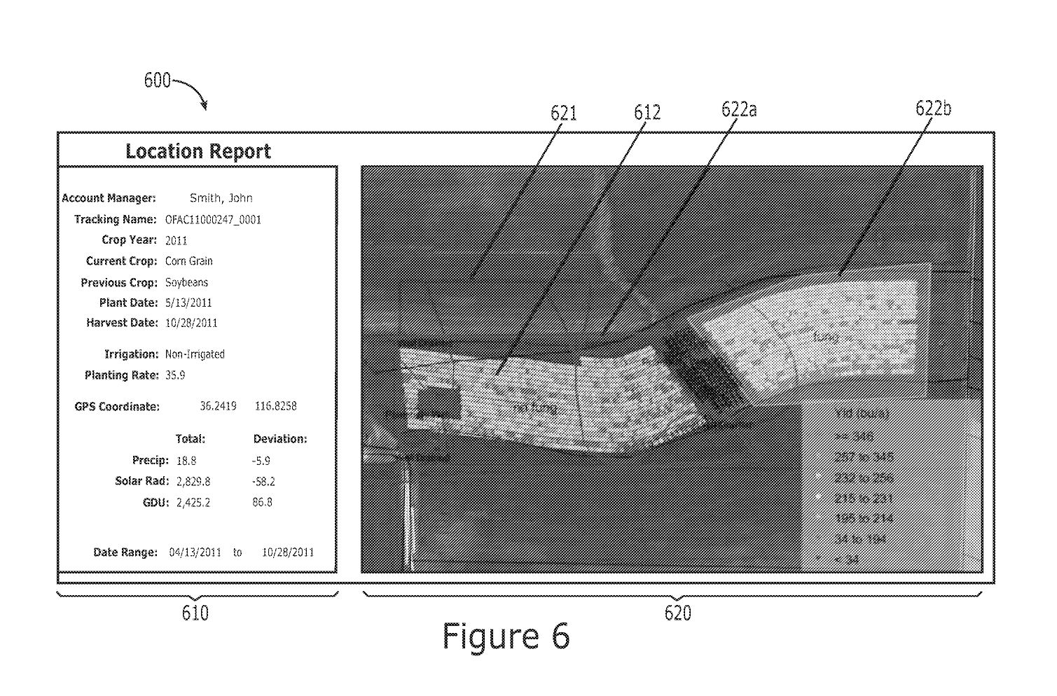

FIG. 6 depicts a location report 500 which may be generated according to an example embodiment. As shown, the location report 500 may include locational information 610 which may, for example, include a summary of information from data points associated with the location to which the location report pertains. The location report 500 may also include a graphical geographic representation 620 which may include one or more data points 612 displayed in conjunction therewith. The location report 500 may also include one or more informational layers 621, 622. For example, the depicted location report 500 includes an informational layer which conveys information regarding soil drainage 621 and informational layers conveying information regarding fungicide usage 622a, 622b.

As described above, FIGS. 3a and 3b illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 208 of an apparatus 200 employing an embodiment of the present invention and executed by a processor 202 of the apparatus 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included, some of which are shown in dashed lines in FIGS. 3a and 3b. Modifications, additions, or enhancements to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A method for comparing a plurality of agricultural inputs, the method comprising:
receiving selection of one or more primary agricultural inputs and one or more comparison agricultural inputs;
accessing, via an apparatus, one or more primary data points, each primary data point respectively comprising at least one geographic location and at least one performance measurement regarding at least one of the primary agricultural inputs;
accessing, via the apparatus, one or more comparison data points, each comparison data point respectively comprising at least one geographic location and at least one performance measurement regarding at least one of the comparison agricultural inputs;
determining, based on the primary and comparison data points, one or more comparative performance data points, each comparative performance data point respectively comprising at least one geographic location and at least one indication of a performance advantage or disadvantage; and
causing information regarding the comparative performance data points to be displayed.

2. The method of claim 1, wherein the performance measurements comprise measurements collected via at least one of: weighing, a yield monitoring system, one or more sensors, observation, or one or more predictions.

3. The method of claim 1, wherein determining, based on the primary and comparison data points, one or more comparative data points comprises performing one or more data processing techniques on one or more of the primary and comparison data points.

4. The method of claim 3, wherein the data processing techniques comprise one or more of the following: paired T-testing, variance analysis, paired regression analysis, multivariate regression analysis, cluster analysis, partial least squares analysis, mixed model analysis, correlation analysis, means testing, multiple range testing, or biploting.

5. The method of claim 4, wherein the data processing techniques comprise one or more machine learning or modeling approaches.

6. The method of claim 1, wherein causing information regarding the comparative performance data points to be displayed comprises:
causing a graphical geographic representation to be displayed, and
causing respective graphical representations of the comparative performance data points to be displayed overlaying the graphical geographic representation.

7. The method of claim 6, wherein the graphical representations of the comparative performance data points are displayed in accordance with a visual coding scheme.

8. The method of claim 6, further comprising receiving selection of a graphical representation of a particular comparative performance data point and, in response, causing information regarding a geographic location associated with the particular comparative performance data point to be displayed.

9. The method of claim 6, further comprising causing one or more informational layers to be displayed in conjunction with the graphical geographic representation.

10. The method of claim 1, wherein causing information regarding the comparative performance data points to be displayed comprises causing a tabular representation of at least the comparative performance data points to be displayed.

11. The method of claim 1, wherein the at least one performance measurement regarding at least one of the comparison agricultural inputs comprises a benchmark performance measurement representing at least one of a typical, expected, or desired performance outcome.

12. The method of claim 1, wherein causing information regarding the comparative performance data points to be displayed comprises causing a graphical representation information regarding circumstances surrounding the performance measurements.

13. The method of claim 1, further comprising receiving at least one filtering criteria, wherein determining, based on the primary and comparison data points, one or more comparative performance data points comprises determining the one or more comparative performance data points based on those primary and comparison data points that satisfy the at least one filtering criteria.

14. The method of claim 13, wherein the at least one filtering criteria comprises a geographic area, and further wherein accessing the one or more primary data points and the one or more comparison data points that satisfy the at least one filtering criteria comprises accessing those primary and comparison data points which comprise at least one geographic location that is within the geographic area.

15. The method of claim 1, further comprising determining, based on one or more commonalities, one or more comparative sets comprising at least one primary group comprising at least one of the one or more primary data points and at least one comparison group comprising at least one of the one or more comparison data points;
wherein determining, based on the primary and comparison data points, one or more comparative performance data points comprises determining the one or more comparative performance data points based on the comparative sets.

16. The method of claim 15, wherein the one or more commonalities comprise at least one of a geographic location, an experiment, an additional agricultural input applied, a time period, an application method, a phenological stage, environmental or weather information, soil characteristics, or a growth year.

17. The method of claim 15, further comprising filtering the one or more comparative sets based on one or more comparison options, wherein determining the one or more comparative performance data points based on the comparative sets comprises determining the one or more comparative performance data points based on the filtered comparative sets

18. The method of claim 17, wherein the one or more comparison options comprise at least one of a data point threshold, a location number threshold, a relative maturity difference threshold, a proximity threshold, or a data quality parameter.

19. An apparatus for comparing a plurality of agricultural inputs, the apparatus comprising at least one processor and at least one memory storing computer program code therein, the memory and computer program code being configured, with the processor, to cause the apparatus to at least:
receive selection of one or more primary agricultural inputs and one or more comparison agricultural inputs;
access one or more primary data points, each primary data point respectively comprising at least one geographic location and at least one performance measurement regarding at least one of the primary agricultural inputs;
access one or more comparison data points, each comparison data point respectively comprising at least one geographic location and at least one performance measurement regarding at least one of the comparison agricultural inputs;
determine, based on the primary and comparison data points, one or more comparative performance data points, each comparative performance data point respectively comprising at least one geographic location and at least one indication of a performance advantage or disadvantage; and
cause information regarding the comparative performance data points to be displayed.

20. A computer program product for comparing a plurality of agricultural inputs, the computer program product comprising a non-transitory computer-readable storage medium having program code instructions stored therein, the program code instructions being configured to, upon execution, cause an apparatus to at least:
receive selection of one or more primary agricultural inputs and one or more comparison agricultural inputs;
access one or more primary data points, each primary data point respectively comprising at least one geographic location and at least one performance measurement regarding at least one of the primary agricultural inputs;
access one or more comparison data points, each comparison data point respectively comprising at least one geographic location and at least one performance measurement regarding at least one of the comparison agricultural inputs;
determine, based on the primary and comparison data points, one or more comparative performance data points, each comparative performance data point respectively comprising at least one geographic location and at least one indication of a performance advantage or disadvantage; and
cause information regarding the comparative performance data points to be displayed.
